(19) United States
(12) Patent Application Publication
(10) Pub. No.: US 2024/0331571 A1
(43) Pub. Date: Oct. 3, 2024

(54) TRAINING AID ASSEMBLY

(71) Applicant: Artisan Medical Displays, LLC, Zeeland, MI (US)

(72) Inventors: Jordan Vander Kolk, Zeeland, MI (US); Jeremy Byington, Zeeland, MI (US)

(21) Appl. No.: 18/618,958

(22) Filed: Mar. 27, 2024

Related U.S. Application Data
(60) Provisional application No. 63/455,234, filed on Mar. 28, 2023.

(51) Int. Cl. G09B 23/30; G09B 23/34

(52) U.S. Cl. CPC G09B 23/303; G09B 23/34

(57) ABSTRACT

A training aid assembly comprising a case, a display stand and a body part. The case includes a base, a wall structure and a top cover. The display stand has a body. The body part may simulate a body part of an animal, including but not limited to a human body part. Fluid ports may be provided so as to allow for the ingress and egress of fluid relative to the cavity defined by the case. Methods are likewise disclosed.

### CROSS-REFERENCE TO RELATED APPLICATION

This application claims priority to U.S. Provisional Patent Application Ser. No. 63/455,234, filed Mar. 28, 2023, entitled “TRAINING AID ASSEMBLY”, the entire specification of which is hereby incorporated by reference.

### BACKGROUND OF THE DISCLOSURE

### 1. Field of the Disclosure

The disclosure relates in general to training aids, and more particularly, to a training aid assembly which is well suited for use in association with, for example, training of medical procedures, and training of medical procedures where there is involvement of fluid.

### 2. Background Art

Surgical training aids have long been known in the art. In addition to training on cadavers, due to a number of different issues, it has been increasingly important to practice surgical procedures in a repeatable environment and one that does not rely on cadavers.

While a number of different types of training aids have been developed, there is a constant desire to create training aids for surgical procedures that provide increasing levels of realism and which can be controlled to provide different operating environments. At the same time, it is desirable to create such training aids which do not sacrifice performance, while providing improved and/or reduce costs. By focusing on the same, additional training opportunities can be presented to a greater number of surgeons and training surgeons.

### SUMMARY OF THE DISCLOSURE

The disclosure is directed to a training aid assembly that includes a base, a wall structure and a display stand. The base has an outer perimeter and a top surface. The wall structure comprises a front wall, a back wall opposite the front wall, with a first side wall joining the front wall and the back wall on a first side, and a second side wall joining the front wall and the back wall on a second side. The base and the wall structure defining a cavity. The display stand has a body positioned on the base and within the cavity. The display stand is structurally configured to retain a model of a body part. The wall structure includes at least one opening port providing fluid communication with the cavity.

In some configurations, the at least one opening port includes a coupling for attachment to an outside structure.

In some configurations, the at least one opening port further comprises a first opening port and a second opening port spaced apart from the first opening port.

In some configurations, at least one of the first opening port and the second opening port are spaced apart from the top surface of the base.

In some configurations, each of the first opening port and the second opening port are spaced apart from the top surface of the base, and positioned on the same one of the front wall, the back wall, the first side wall and the second side wall.

In some configurations, each of the first opening port and the second opening port are positioned on the back wall.

In some configurations, the first opening port is positioned proximate the first side wall and the second opening port is positioned proximate the second side wall.

In some configurations, the wall structure further defines an upper edge, with the upper edge having a flange defining a surface.

In some configurations, the flange extends inwardly from the wall structure.

In some configurations, the training aid further includes a top cover that extends over the upper edge, resting upon the flange.

In some configurations, the top cover is structurally configured to mimic skin.

In some configurations, the top cover comprises a silicone sheet material.

In some configurations, the flange further includes a fastening member which attaches a lower surface of the top cover to the flange.

In some configurations, the fastening member releasably attaches the lower surface of the top cover to the flange.

In some configurations, the base further includes an inner display slot, with the display stand positionable within the display slot.

In some configurations, the display stand further comprises a body defining a bed. A plurality of fingers extend upwardly away from the top surface of the base on either side of the bed.

In some configurations, the body part model comprises a portion of a spine, wherein a vertebral body of the body part is received on the bed, and each of the plurality of fingers receives a transverse processes of the body part.

In some configurations, the plurality of fingers comprises four fingers.

In some configurations, the base includes an outer wall slot extending thereabout. A lower end of the wall structure is positionable within the outer wall slot.

In some configurations, the wall structure is transparent.

### BRIEF DESCRIPTION OF THE DRAWINGS

The disclosure will now be described with reference to the drawings wherein:

FIG. 1 of the drawings is a font side perspective view of the training aid apparatus of the present disclosure;

FIG. 2 of the drawings is a back side perspective view of the training aid apparatus of the present disclosure;

FIG. 3 of the drawings is a font side perspective view of the training aid apparatus of the present disclosure, showing the contents of the cavity and a transparent wall structure;

FIG. 4 of the drawings is a back side perspective view of the training aid apparatus of the present disclosure, showing the contents of the cavity and a transparent wall structure;

FIG. 5 of the drawings is a perspective view of the display stand of the training aid assembly of the present disclosure;

FIG. 6 of the drawings is a perspective view of the base of the case of the training aid assembly of the present disclosure;

FIG. 7 of the drawings is a cross-sectional view of the training aid assembly of the present disclosure; and

FIG. 8 of the drawings is a cross-sectional view of the training aid assembly of the present disclosure.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

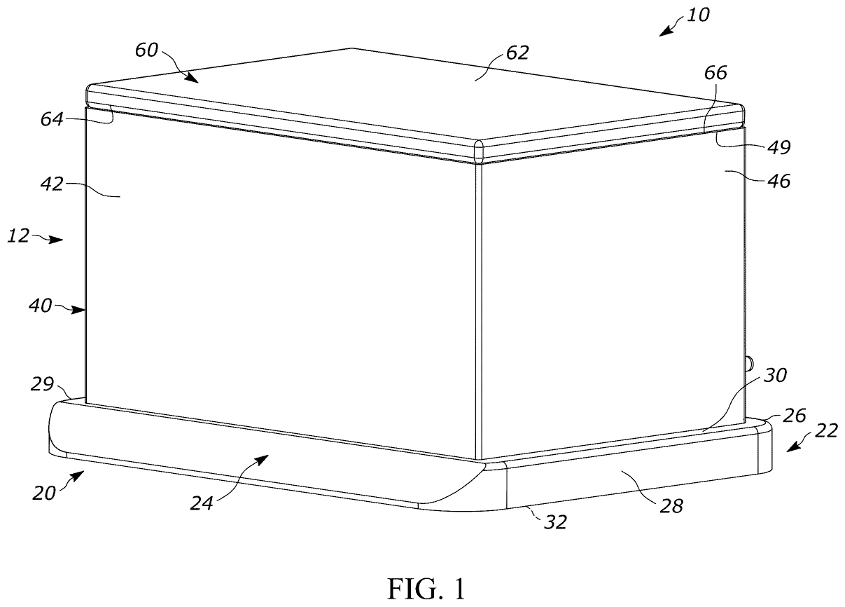

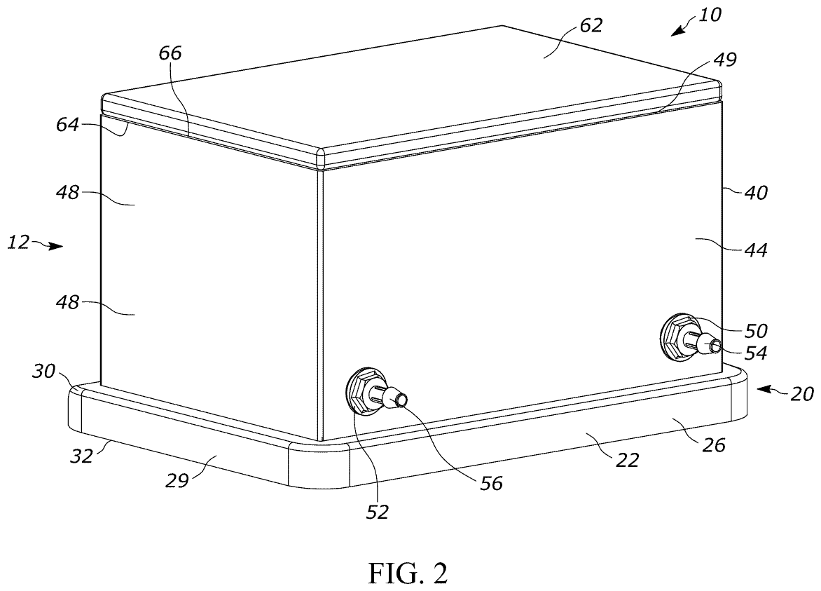

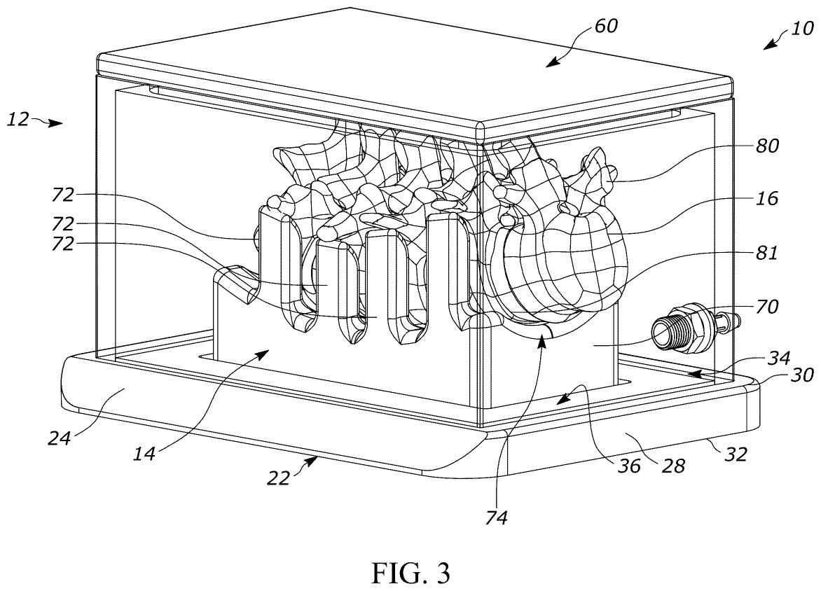

Referring now to the drawings and in particular to FIGS. 1 through 4, the training aid assembly is shown generally at 10. The training aid assembly includes case 12, display stand 14 and body part model 16. The training aid in the configuration shown is configured for use in association with a portion of a human spine, however the use thereof is not limited to a spine or another body part.

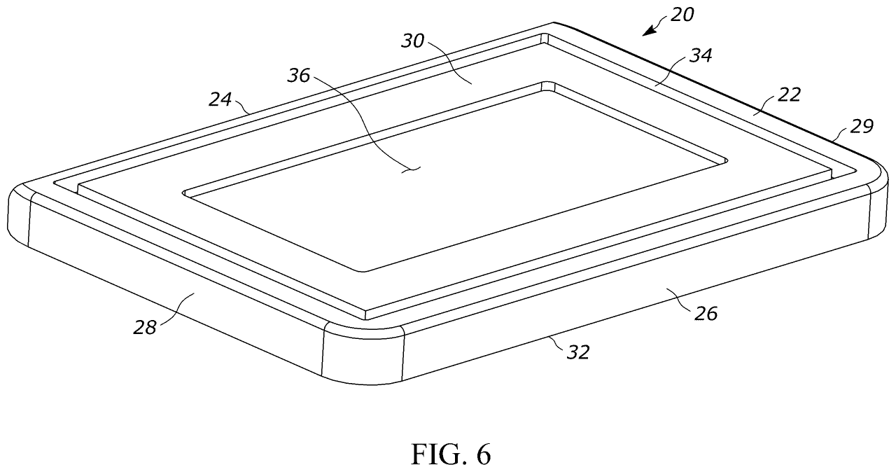

With reference to FIG. 1 through 4, the case includes base 20, wall structure 40 and top cover 60. The case components define a cavity, with the wall structure defining an upper opening. With additional reference to FIG. 6, base 20 is defined by perimeter 22, top surface 30, bottom surface 32, outer wall slot 34 and inner display slot 36. The base 20 may be formed from a polymer member, which may be cast, molded, extruded, or otherwise formed. Other materials, such as metal alloys, as well as natural materials such as wood, and also composites may be utilized. The perimeter 22 includes front 24, back 26, first side 28 and second side 29. The front 24 may include an angled face, upon which indicia may be applied. The remaining sides may be substantially vertical and substantially perpendicular to the top surface and the bottom surface. Of course, other configurations and relationships between the walls are contemplated.

It will be understood that in the configuration shown, the inner display slot 36 is configured to receive the display stand 14 thereon. The outer wall slot 34 is configured to receive the wall structure therein. In the configuration shown, the outer wall slot 34 is generally follows the perimeter 22, although variations are likewise contemplated.

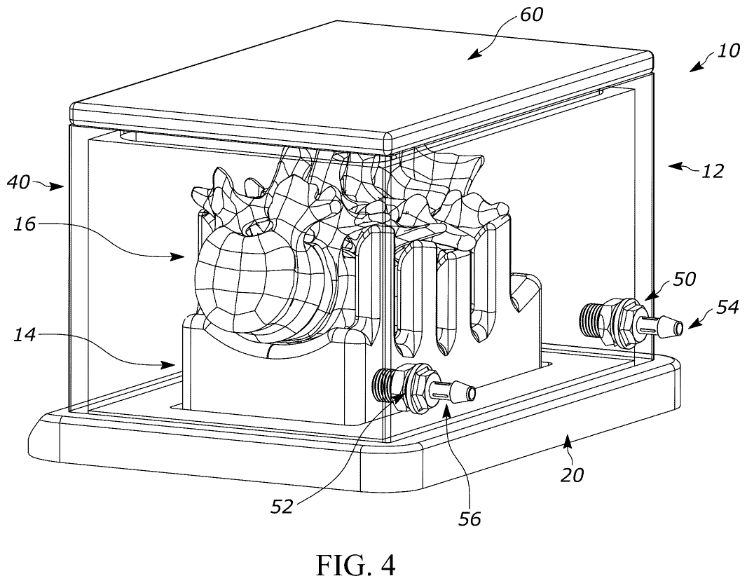

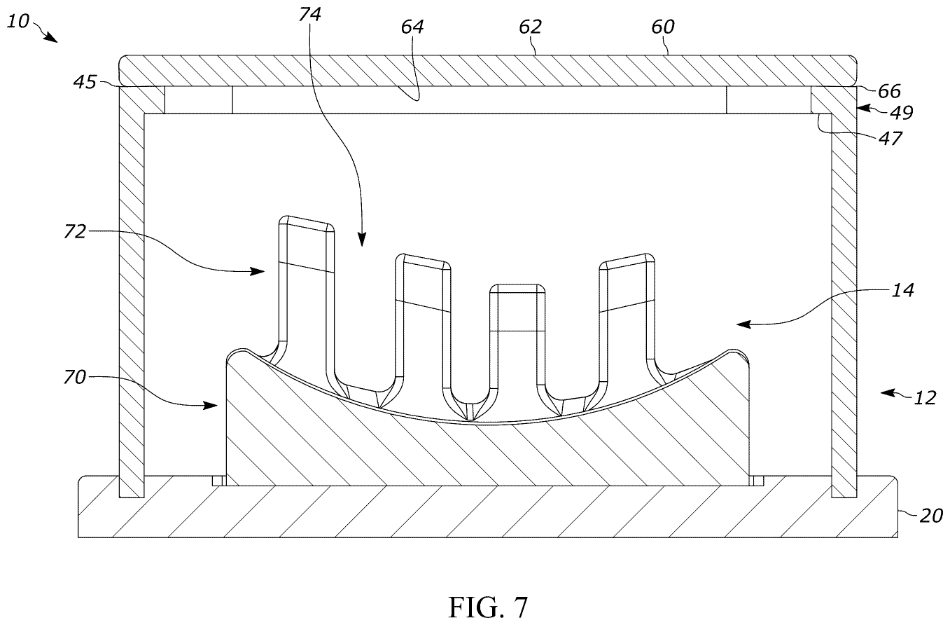

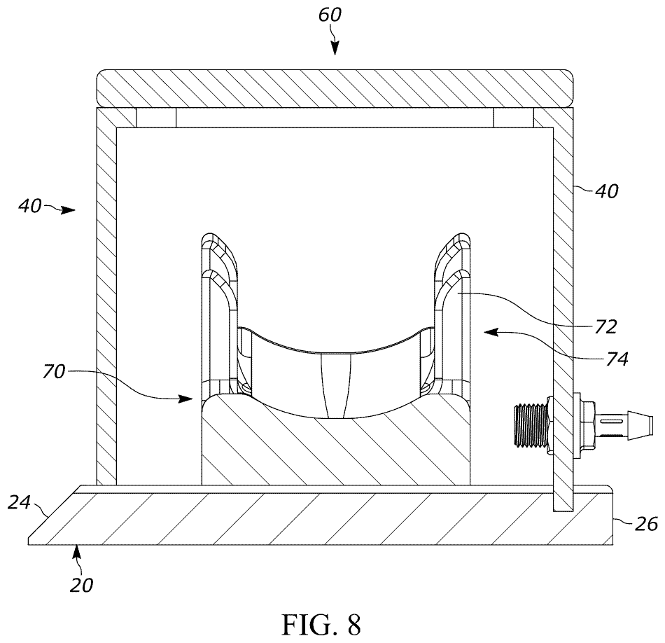

The wall structure 40 is shown as comprising front wall 42, back wall 44, first side wall 46, second side wall 48 and upper edge 49. The front wall 42 is generally parallel to the back wall 44 and spaced apart therefrom. The first side wall 46 and the second side wall 48 are spaced apart from each other and span between the front wall and the back wall in a generally perpendicular manner, thus forming a rectangular cubic configuration with the base forming the bottom wall, and having an open top defined by the upper edge 49 (as a perimeter). With reference to FIGS. 4, 7 and 8, the upper edge defines an inwardly directed flange 47, the outer surface of which provides sufficient area for the receipt and retention of fasteners such as hook and loop fasteners.

In the configuration shown, the wall structure comprises a transparent material, such as a transparent polymer. Of course, in other configurations, a combination of transparent, translucent, and/or opaque walls may be used, or the entirety may be formed from any of the foregoing. Additionally, the wall structure may be formed from a single integrally formed component, or, may be formed from a plurality of components that are joined together through adhesion, welding or otherwise. Advantageously, by providing transparent structures, the ability to capture video or viewing from different angles provides an improved surgical training experience and provides different views from which to view the procedure.

In the configuration shown, the lower edge of the wall structure generally corresponds to the outer wall slot 34 so as to fit within the lower edge. Such a fit may be fluid tight. In other configurations, a sealant, an adhesive or a gasket can be utilized to join the components in a generally fluid tight manner so as to define a cavity. The back wall 44 includes first opening port 50 and second opening port 52 spaced apart from the first opening port 50. The ports are generally spaced apart from the base 20 and positioned proximate opposing side walls 46, 48. Each of the first and second opening ports include a coupling to which a tubular member may be coupled. Such opening ports can be used as outlet or inlet ports, and they may be connected to drains, pumps fluid supplies or otherwise, without limitation.

The top cover 60 is shown in FIGS. 4, 7 and 8, as comprising upper surface 62 and lower surface 64. The top cover is formed from a flexible material, which may be formed from multiple layers of material so as to mimic the skin of a user. Such a flexible material may be configured with slots, or may be configured to be puncturable by, for example, medical tools, such as scalpels, knives, blades, needles, scissors or the like. In some configurations, the material may comprise a silicone material, which may include layers of different durometers, and which may include mesh layers which simulate fascia or other structures. Preferably, the top cover provides a realistic structure for the user to receive an enhanced experience of puncturing the skin. One such example are structures and the like that form artificial skin, sold under the mark TruSkin, which has been available from the Applicant of the present disclosure.

A fastening system may be utilized to attach the top cover to the upper edge of the wall structure. In some configurations, a hook and loop fastener 45 may be utilized to couple the lower surface of the top cover to the upper edge of the wall structure, about the perimeter 49 thereof, and more particularly about flange 47. As such, the top cover can easily be removed, while providing the necessary attachment force to preclude inadvertent removal. In other configurations, the outer edge of the top cover may include a channel that matingly engages with the upper edge of the wall structure. In still other configurations, clamps, pins, snap fit configurations, adhesives or other binding structures may be utilized.

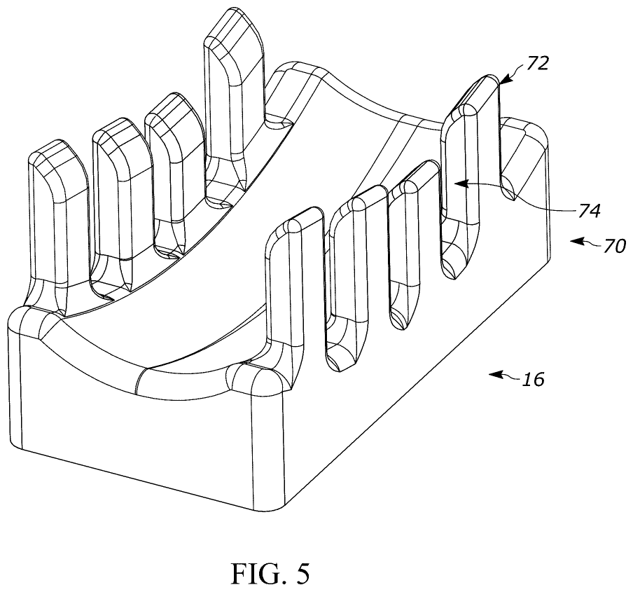

Display stand 14 is configured to releasably retain and hold a body part (although it is not limited to body parts or human anatomy, or anatomy of an animal). In the particular configuration, and with reference to FIGS. 5, 7 and 8, the body part 16 comprises a portion of the spine. It will be understood that in addition to bone, such as bone 80, soft tissue, such as soft tissue 81, that forms a portion of the spinal area (such as, for example, discs, spinal nerves, dura matter of the spinal cord, among others) may likewise be included, without limitation. In the configuration shown, the display stand includes body 14 having a plurality of fingers, such as fingers 72 extending generally upwardly from opposing sides thereof, to define valley 74 therebetween.

In the configuration shown, the display stand comprises four fingers that extend from a bed, wherein the bed receives the back of the vertebral body, and each of the fingers receives and/or retains one of the transverse processes. It is contemplated that the vertebral body is suspended over the bed through the transverse processes interfacing with the fingers. As the portion of the spine is curved, the bed is curved, and the fingers extend to different heights from the top surface of the base. Of course, the configuration of the bed and the fingers can be modified when retaining a different portion of the spine, or a different body component.

In operation, training aid assembly may be provided. In particular, a body part 16 may be positioned on the display stand 14 within the case 12. It will be understood that the display stand may be affixed to the base 20, or may be releasably coupled thereto, or may be freely positioned within the inner display slot. The body part 16 may be positioned on the display stand. The ports can be utilized to circulate fluid, send fluid, or remove fluid. In more detail, and among other options and configurations, in some configurations, the body part may be flooded (i.e., submerged), or there may be active flushing, so that fluid is washing across the body part. Of course, other fluid movements are likewise contemplated.

In particular, to utilize the training aid assembly, the body part is positioned on the display stand in the operable position, and releasably retained thereby. Next, one or both of the ports are connected to one of a pump and a drain. In one example, one of the ports may be connected to a pump and the other port may be connected to a drain. In another configuration, the case may be filled with a fluid, and the port can each be connected to opposite sides of pump, wherein activation of the pump circulates fluid within the case. In another configuration, fluid may be pumped into the case through one of the ports with the other port being blocked, such that the level of fluid increases. In another configuration, fluid may be placed into the case, with one or both of the ports being connected to a drain, wherein fluid can be selectively drained from the port as desired. In another configuration, the rate of removal and the rate of supply of fluid to the display may be controlled such that fluid is removed at a different rate than fluid is supplied. Any number of other configurations are contemplated.

Once the desired fluid movement is ascertained, a user may puncture the top cover with any one or more devices or tools. Once punctured, the user can utilize instruments to perform procedures on the body part. In some configurations, instead of puncturing the top cover, the top cover may be removed completely prior to performing procedures on the body part. Once the procedure is completed, the fluid can be drained, the body part can be removed and both the body part and the case and display stand can be cleaned.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A training aid assembly comprising:
a base having an outer perimeter and a top surface;
a wall structure comprising a front wall, a back wall opposite the front wall, with a first side wall joining the front wall and the back wall on a first side, and a second side wall joining the front wall and the back wall on a second side, the base and the wall structure defining a cavity; and
a display stand having a body positioned on the base and within the cavity, the display stand structurally configured to retain a model of a body part,
wherein the wall structure includes at least one opening port providing fluid communication with the cavity.

2. The training aid assembly of claim 1 wherein the at least one opening port includes a coupling for attachment to an outside structure.

3. The training aid assembly of claim 1 wherein the at least one opening port further comprises a first opening port and a second opening port spaced apart from the first opening port.

4. The training aid assembly of claim 3 wherein at least one of the first opening port and the second opening port are spaced apart from the top surface of the base.

5. The training aid assembly of claim 4 wherein each of the first opening port and the second opening port are spaced apart from the top surface of the base, and positioned on the same one of the front wall, the back wall, the first side wall and the second side wall.

6. The training aid assembly of claim 5 wherein each of the first opening port and the second opening port are positioned on the back wall.

7. The training aid assembly of claim 6 wherein the first opening port is positioned proximate the first side wall and the second opening port is positioned proximate the second side wall.

8. The training aid assembly of claim 1 wherein the wall structure further defines an upper edge, with the upper edge having a flange defining a surface.

9. The training aid assembly of claim 8 wherein the flange extends inwardly from the wall structure.

10. The training aid assembly of claim 9 wherein the training aid further includes a top cover that extends over the upper edge, resting upon the flange.

11. The training aid assembly of claim 10 wherein the top cover is structurally configured to mimic skin.

12. The training aid assembly of claim 11 wherein the top cover comprises a silicone sheet material.

13. The training aid assembly of claim 11 wherein the flange further includes a fastening member which attaches a lower surface of the top cover to the flange.

14. The training aid assembly of claim 13 wherein the fastening member releasably attaches the lower surface of the top cover to the flange.

15. The training aid assembly of claim 1 wherein the base further includes an inner display slot, with the display stand positionable within the display slot.

16. The training aid assembly of claim 1 wherein the display stand further comprises a body defining a bed, with a plurality of fingers extending upwardly away from the top surface of the base on either side of the bed.

17. The training aid assembly of claim 16 wherein the body part model comprises a portion of a spine, wherein a vertebral body of the body part is received on the bed, and wherein each of the plurality of fingers receives a transverse processes of the body part.

18. The training aid assembly of claim 17 wherein the plurality of fingers comprises four fingers.

19. The training aid assembly of claim 1 wherein the base includes an outer wall slot extending thereabout, with a lower end of the wall structure positionable within the outer wall slot.

20. The training aid of claim 19 wherein the wall structure is transparent.
